(19) United States
(12) Patent Application Publication
(10) Pub. No.: US 2005/0253304 A1
(43) Pub. Date: Nov. 17, 2005

(54) Process for obtaining a tire tread

(75) Inventor: Gilbert Menard, Volvic (FR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 11/125,134

(22) Filed: May 10, 2005

Related U.S. Application Data
(60) Provisional application No. 60/586,281, filed on Jul. 9, 2004.

(30) Foreign Application Priority Data
May 10, 2004 (FR) 04/05049

(51) Int. Cl. B29C 35/00

(52) U.S. Cl. 264/400; 152/209.17; 264/326

(57) ABSTRACT

A process for obtaining a tread 21 comprising a running surface bounded axially by lateral faces, a groove 61 and a channel located radially below the tread and opening onto at least one lateral face of the tread 21 and into at least one sidewall 15 of the groove 61, this process comprising (a) the molding of the tread 21, the channel extending inside the groove 61 such that a plane 101 which is locally tangential to the part, radially external to the channel, of the sidewall 15 into which the channel opens divides the channel into two parts 115 and 215; and (b) the ablation of at least part of the mix molded around the channel inside the groove 61, with a cutting tool that follows the profile of the groove 61.

### FIELD OF THE INVENTION

The present invention concerns processes for the fabrication of tires or treads for tires.

### Definitions

In this document the terms “axial” and “axially” refer to a direction essentially parallel to the rotation axis of a tire. When these terms are applied to a tread, they refer to the direction parallel to the rotation axis of the tire once the tread is fixed on the tire. In other words, the axial direction is the direction perpendicular both to the thickness of the tread and to the circumference of the tire.

The terms “radial” and “radially” refer to a direction parallel to a vector perpendicular to the axial direction and which intersects the rotation axis of a tire. When these terms are applied to a tread they refer to the directions parallel to a vector perpendicular to the tire's rotation axis and comprising a point on the tire's rotation axis once the tread is incorporated on the tire. In other words, a radial direction is a direction parallel to the thickness of the tread.

The terms “circumferential” and “circumferentially” refer to a direction which is perpendicular both to the axial and radial directions.

“Running surface” of a tire tread is understood to mean the surface formed by the points of the tread that come into contact with the ground when the tire is rolling.

“Lateral face” of a tire tread means any part of the surface of the tread which extends from the axial ends of the running surface to the sidewalls of the tire. When considering a tread before it has been incorporated on a tire, a lateral face consists of the part of the tread's surface that connects one of the axial edges of the running surface to the surface designed to come into contact with the carcass of the tire.

“Pin” is understood to mean any molding element designed to mold a cavity at least part of which is located below the mold surface that molds the running surface and which opens onto at least one lateral face of the tread, without any limitation of its geometry.

“Channel” means a cavity molded by a pin.

“Inside surface” of a channel means the surface formed by the points of the tread that were in contact with the surface of the pin just before unmolding.

“Mix” or “rubber mix” means a rubber composition containing at least one elastomer and filler.

“Groove” means a recess molded in the tread and delimited laterally by sidewalls made of mix, the mean width separating those sidewalls being equal to at least 2 mm.

“Protuberance” means a quantity of mix located at the interface between a groove of a tread and a channel molded in the tread, and forming a protrusion on the part, radially exterior to the channel, of the surface of the groove's sidewall into which the channel opens.

The term “tire” here denotes any type of elastic casing, whether inflated or not and whether or not subjected to an internal pressure during use.

### TECHNOLOGICAL BACKGROUND

It has long been known that the presence of channels located below the running surface of a tire and opening onto a lateral face of the tread can confer advantageous properties on the tire, particularly when its tread is thick. The channels render the pattern of the tread evolutional, since they emerge at the surface of the tread as the wear of the tread progresses, so favoring grip on wet ground without sacrificing the rigidity of the tread when new. Moreover, the channels contribute towards cooling the shoulders of the tire (by a ventilation effect) and consequently improve is endurance. This thermal effect is amplified when the channel opens not only onto a lateral face of the tread, but also into a groove of the tread.

Patent application EP 1 232 852 describes a mold and a molding process for a tread comprising this type of channel. The mold comprises crown sectors that can move radially and that have ridges designed to mold grooves, and shoulder sectors that can move radially and axially, among which at least some have pins designed to mold the axial channels. In a preferred embodiment, these pins make contact with the ridges during the penetration of the pins into the mix forming the tread, in order to resist the pressure exerted by the mix to be molded.

This molding process has demonstrated its efficiency; in use, however, it has been found that a film of the mix can form randomly between the surface of the pin and the ridge with which the said pin comes into contact. The formation of this film is favored by high molding pressures (of the order of 10 bar) which enhance the flowing of the mix into the space left by the clearance between the pin and the ridge. The dimensions of the film result, among other things, from the tolerances with which the mold components are made, the thermal conditions and conditions of use, and the wear of the mold's components. In the mold described in patent application EP 1 232 852, the film is not necessarily broken during the axial withdrawal of the pin, nor during the radial withdrawal of the crown sector. If the film remains wholly or partially in place, it blocks the orifice connecting the channel and the groove; consequently, the channel's contribution towards the draining of water and towards lowering the working temperature of the parts of the tire that surround it, in particular the tire's shoulders, is reduced or even inexistent.

The same phenomenon has been observed in other molds. Patent EP 925 907 describes a mold with pins for molding part of a tire tread, this mold comprising at least one molding element designed to mold a recess in the tread, two of the main walls of the recess being provided with at least one connection element connecting those walls. The molding element consists of a first and a second part: the first part constitutes a support and the second part comprises at least one pin designed to be assembled with the first part so as to form at least one orifice for molding the connection elements that connect the main walls of the recess. The clearance required for the positioning of the pins in the support leads to the formation of films of the mix. Since only part of the films are broken when the pins are withdrawn, it is proposed to provide, in each pin passage and on each pin, threads enabling each pin to be screwed in place. This considerably reduces the amount of mix that can penetrate into each passage. Besides, the rotation movement imposed on each pin when unscrewing it shears and so breaks the film formed between each pin and the pin passages. A disadvantage of this solution is that it entails having means for screwing in and unscrewing each pin, which makes molding and unmolding very complicated. A further disadvantage of the solution is that it restricts the geometry of each pin, because the threaded zones necessarily have to be cylindrical.

Patent EP 1 275 527 also mentions the formation of films of mix between two molding elements before vulcanization and suggests to provide the ends of the molding elements with sharp blades in order to separate these small quantities of mix from the tread at the very moment of their formation.

The invention aims at obtaining a channel located radially below the running surface of a tire tread and opening both onto a lateral face of the tread and into at least one sidewall of at least one groove of the tread without being blocked by a film of mix.

Thus one principle of the present invention is to create a molding “defect” in an easily accessible zone so that it can be removed without difficulty.

This objective is achieved by a process for obtaining a tread made of a mix, the said tread having a running surface bounded axially by lateral faces, at least one groove bounded by two sidewalls, and at least one channel located radially below the running surface and opening onto at least one lateral face of the tread and into at least one sidewall of at least one groove, the said process comprising the following stages:
molding of the tread with at least one groove and at least one channel opening onto at least one lateral face of the tread, this channel extending into the groove in such manner that at least one plane which is locally tangential to the part, radially external to the channel, of at least one sidewall into which the channel opens, divides the channel into two parts;
ablation, after vulcanization, of at least part of the mix molded around the channel within the groove.

The said ablation is effected after unmolding of the tire or the tread; it can be effected by cutting, by tearing off, by mechanical force after a cryogenic treatment, or by any other known means. Preferably the part of the mix which has to be removed is dimensioned as a function of the means used for ablation. A thin film (having a thickness of less than 0.5 mm) is preferred when the ablation is effected after a cryogenic treatment, a thicker film (having a thickness of more that 0.5 mm) is preferred when there is no such treatment.

In a preferred embodiment, the channel is extended into the groove by a protuberance. Preferably, the axial distance between at least one plane locally tangential to the part, radially external to the channel, of the sidewall on which the protuberance forms a protrusion and the point of the inside surface of the channel closest to the groove sidewall opposite the sidewall on which the protuberance forms a protrusion, is greater than 20% of the mean width of the groove. This makes it easier to reach the protuberance during the ablation step.

In another preferred embodiment, the channel passes across the said groove so that a first part of the channel opens both onto a lateral face of the tread and into one sidewall of the groove, and another part of the channel opens opposite the first part, into the opposite sidewall of the groove. This embodiment has the advantage that the part of the mix molded around the channel within the groove is broken during the unmolding; thus the formation of an orifice is initiated even before the ablation is carried out.

In another preferred embodiment, all the mix surrounding the channel within the said groove at the end of the molding stage is removed during the ablation stage. Thus no part of the mix molded around the channel within the groove and blocking the channel is remaining after the ablation step.

Preferably, ablation is carried out with the tire in rotation, by a blade or grinding wheel introduced into the groove, or by a laser beam, following the profile of the groove. This is one of the major advantages of the process according to the invention: it is possible to reach all the molding “defects” by introducing a means for ablation into the groove(s) and by setting the tire in rotation. Prior art (GB 252 598) knows the principle of forming burrs within channels, but in order to cut the burrs the cutting means have to be introduced into each of the channels, which makes the process heavy and costly.

The effect of the process according to the invention is to localize entirely within the groove the film of mix formed during molding at the interface between the pin that molds the channel and the ridge that molds the groove. If this effect is obtained by a pin which is imprisoned in a radial direction by the ridge that molds the groove, a precise sequence must be respected during extraction from the mold, the pin being withdrawn axially, at last partially, before radially withdrawing the crown sector comprising the ridge that molds the groove and into which the pin is inserted.

The invention will be better understood thanks to the description of the figures, in which:

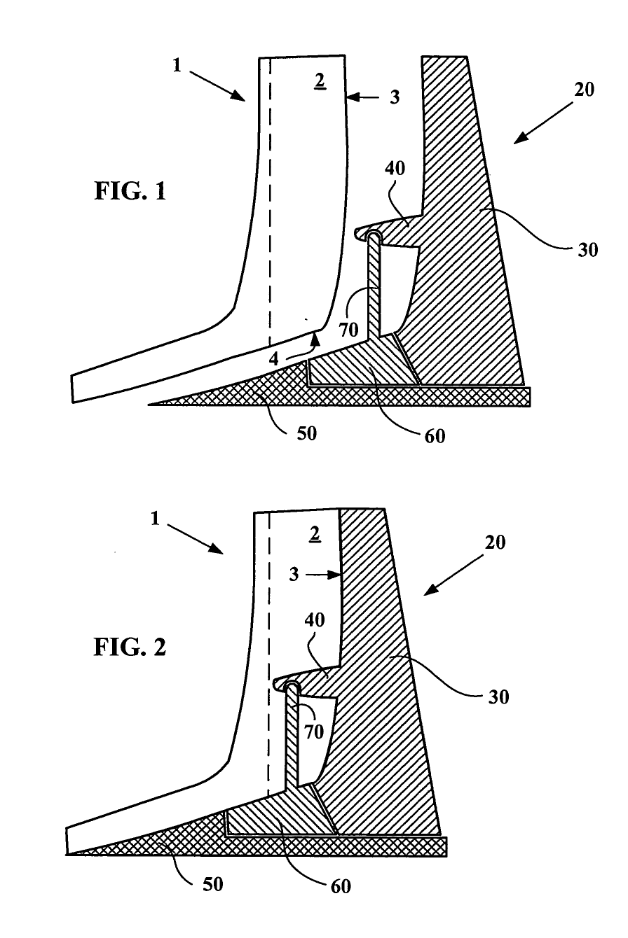

FIG. 1 shows a schematic radial section of part of a mold in its open configuration, and the corresponding part of a tire before molding.

FIG. 2 shows a schematic radial section of part of a mold after the mold has been closed, one pin having completed its radial penetration into the tread of the tire.

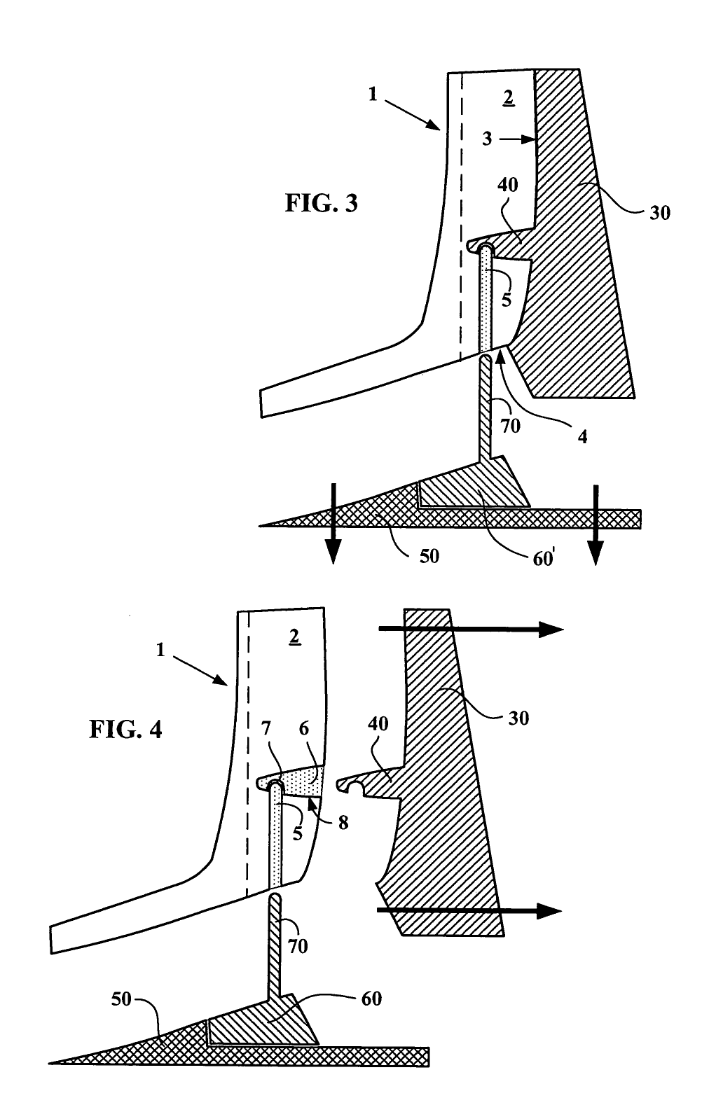

FIG. 3 shows a schematic radial section of part of a mold in a partially open configuration, one pin having been displaced axially after the molding of the tire.

FIG. 4 shows a schematic radial section of part of a mold in the open configuration, a crown sector having been displaced radially, and the corresponding part of a molded tire.

FIG. 5 shows a schematic radial section of part of a molded tire and a cutting device provided in order to remove the mix protuberance that is blocking a channel of the tire.

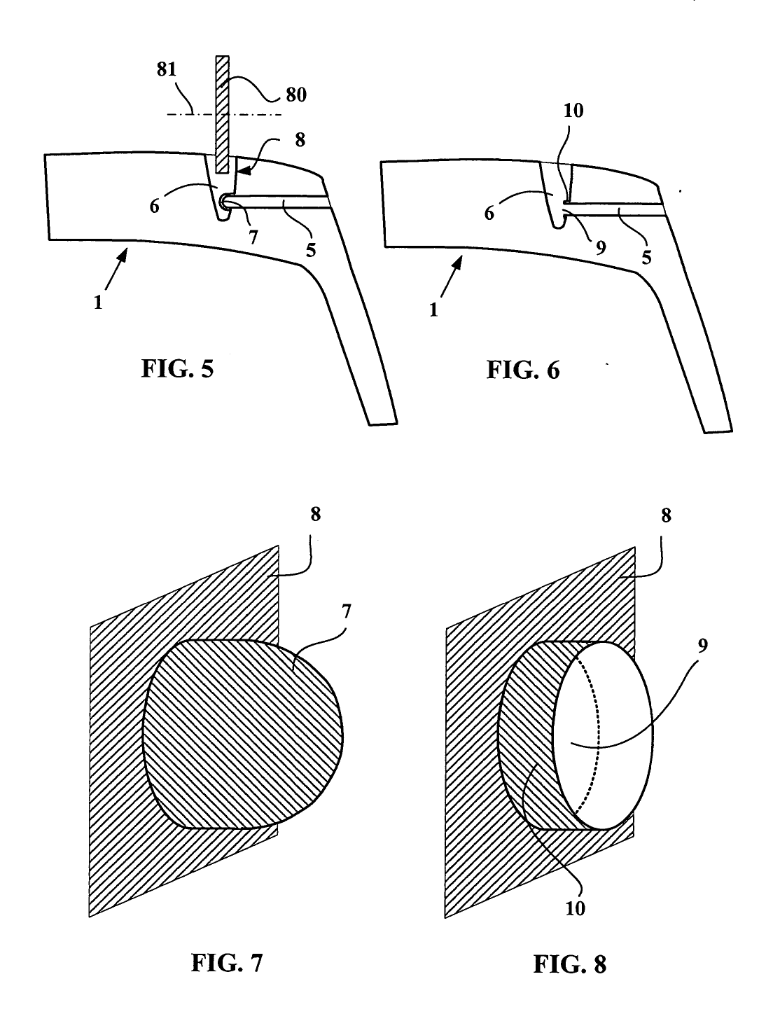

FIG. 6 shows a schematic radial section of part of a molded tire after the protuberance blocking a channel in the tire has been cut off.

FIG. 7 is a schematic representation of a protuberance blocking the orifice of a channel that opens into a sidewall of a groove of the tread.

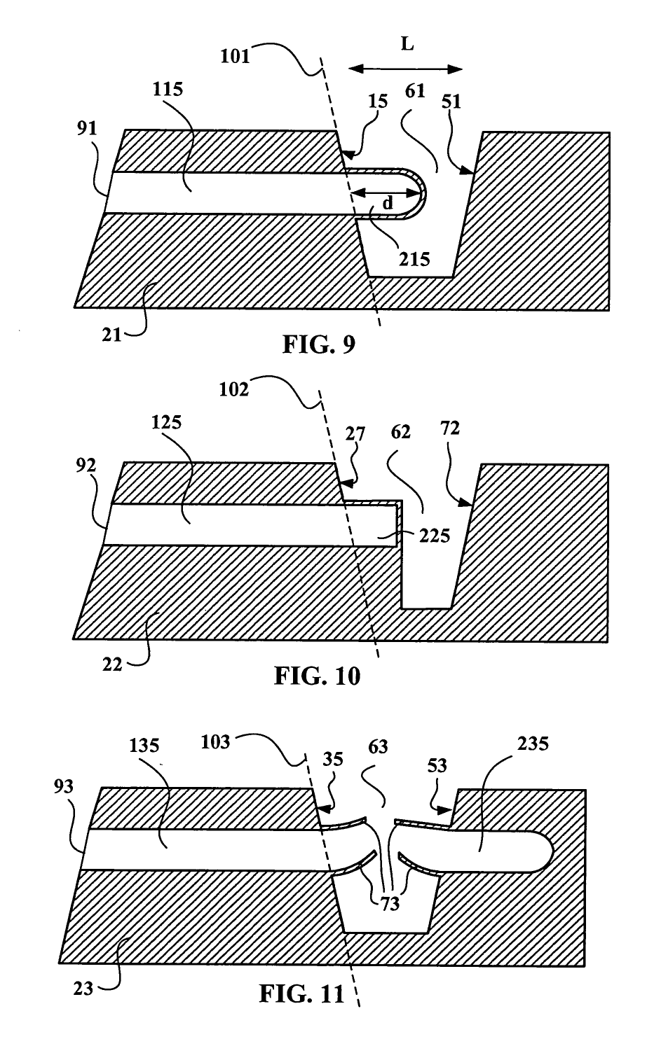

FIG. 8 represents schematically the orifice of a channel opening into the sidewall of a tread groove, after the cutting process.

FIGS. 9 to 13 are schematic representations, in axial section, of part of a tread after extraction from the mold and before the cutting stage.

### DESCRIPTION OF EMBODIMENTS

FIG. 1 shows a schematic radial section of part of a mold 20 in its open configuration and the corresponding part of a tire 1 before molding. In this partial, sectional view a crown sector 30 can be seen, which carries a ridge 40 provided to mold a groove of the tread 2 of the tire 1. This crown sector 30 can move radially relative to the shell 50 that molds the sidewalls of the tire 1 in a manner known as such. The shoulder sector 60 provided to mold the lateral face 4 of the tread 2 carries a pin 70 provided to mold a channel below the running surface 3 of the tire. The shoulder sector 60 can move radially and axially relative to the crown sector 30. In the case illustrated, the pin 70 enters a recess made in the ridge 40 of the crown sector 30, but this is not a limiting characteristic of the process according to the invention, as will be made clear below.

FIG. 2 shows a schematic radial section of part of the mold 20 and the corresponding part of the tire 1 after the mold has been closed. The pin 70 provided for molding a channel below the rung surface 3 of the tire and the ridge 40 provided for molding a groove of the tread 2 have penetrated into the uncured mix of the tread 2.

FIG. 3 shows schematically the first stage of unmolding: the shell 50 and the shoulder sector 60 carrying a pin 70 undergo an axial movement (in the direction indicated by the arrows) so as to extract the pin 70 from its recess in the ridge 40 of the crown sector 30 and from the tread 2 of the tire 1. The channel 5 molded by the pin 70 and opening onto the lateral face 4 of the tread 2 can be seen.

FIG. 4 shows part of the mold 20 and the corresponding part of the tire 1 after the second stage of extraction from the mold: the crown sector 30 undergoes a radial movement (in the direction indicated by the arrows) to extract the ridge 40 from the groove 6 molded in the tread 2 of the tire 1. This groove 6 does not communicate with the channel 5, because a small quantity of the mix has penetrated into the space left by the clearance between the pin 70 and the ridge 40, forming a protuberance 7 on the sidewall 8 of the groove 6.

In the case represented, the pin 70 must be withdrawn at least partially before the crown sector 30 is withdrawn. The example is non-limiting. Depending on the geometries of the pin 70 and the ridge 40, the mold extraction stages mentioned could be inverted or carried out simultaneously.

FIG. 5 is a schematic representation of the second stage of the process according to the invention. After the molding stage, the protuberance 7 formed on the sidewall 8 of the groove 6 is reduced so as to produce an orifice connecting the groove 6 and the channel 5. Cutting is carried out by a grinding wheel 80 rotating about an axis 81. Of course, many other cutting means such as a blade or a laser beam can be used.

FIG. 6 shows schematically part of the tire 1 after cutting off the protuberance 7 (FIG. 5) formed on the sidewall 8 of the groove 6. Since the end of the protuberance 7 has been removed, an orifice 9 now connects the groove 6 and the channel 5. In the present case not all of the film of mix has been cut away; there remains a wall 10 which extends the channel into the groove 6. This example is in no way limiting: it may in fact be preferable to remove all of the film of mix formed within the groove.

FIGS. 7 and 8 show the protuberance 7 on the sidewall 8 of the groove 6 in FIG. 5, viewed in perspective, before and after the ablation stage of the process according to the invention. The wall 10 extending the channel 5 into the groove 6 can be seen.

FIGS. 9 to 13 are schematic representations of treads obtained by the process according to the invention, before the second stage of the process.

FIG. 9 shows part of a tread 21 comprising a groove 61 and a channel extending from an orifice 91 in a lateral face of the tread 21 as far as the inside of the groove 61. The channel opens into a sidewall 15 of the groove 61 but does not cross the groove: one of its ends forms a protuberance inside the groove. One can see the trace of the plane 101 that is locally tangential to the part 15, radially external to the channel, of the sidewall into which the channel opens. This trace divides the channel into two parts 115 and 215. In the present case the axial distance between the plane 101 and the point of the channel's inside surface closest to the opposite sidewall 51 is larger than 50% of the mean width L of the groove. In the example shown, the thickness of the mix surrounding the channel inside the groove 61 is constant. Of course, this does not constitute a limitation of the process. The thickness can vary and, when the mix does not fill up the entire space left by the clearance between the pin molding the channel and the ridge molding the groove 61, there can even be orifices that connect the channel and the groove.

FIG. 10 shows part of another tread 22 comprising a groove 62 and a channel that extends from an orifice 92 in a lateral face of the tread 22 as far as the inside of the groove 62. As in the preceding example, the channel opens into a sidewall 27 of the groove 62 but does not cross the groove: one of its ends forms a protuberance within the groove. The trace of the plane 102 locally tangential to the part 27, radially external to the channel, of the sidewall into which the channel opens, divides the channel into two parts 125 and 225. The mold used to obtain this tread 22 has the advantage that it is not necessary to withdraw the pin molding the channel, even partially, before withdrawing the crown sector that molds the running surface and the groove 62.

FIG. 11 shows part of another tread 23 comprising a groove 63 and a channel extending from an orifice 93 in a lateral face of the tread 23 as far as the inside of the groove 63. In contrast to the last two examples, the channel crosses the groove 63: when the mix has filled the space left by the clearance between the pin molding the channel and the ridge molding the groove 63, it forms a film 73 which extends from the sidewall 35 to the opposite sidewall 53. During the extraction of the ridge that molded the groove 63, this film 73 deforms and then tears. If, during molding, the mix has not filled all the space left by the clearance between the pin molding the channel and the ridge molding the groove 63, extraction of the ridge may be possible without tearing the film 73. The trace of the plane 103 locally tangential to the part 35, radially external to the channel, divides the channel into two parts 135 and 235.

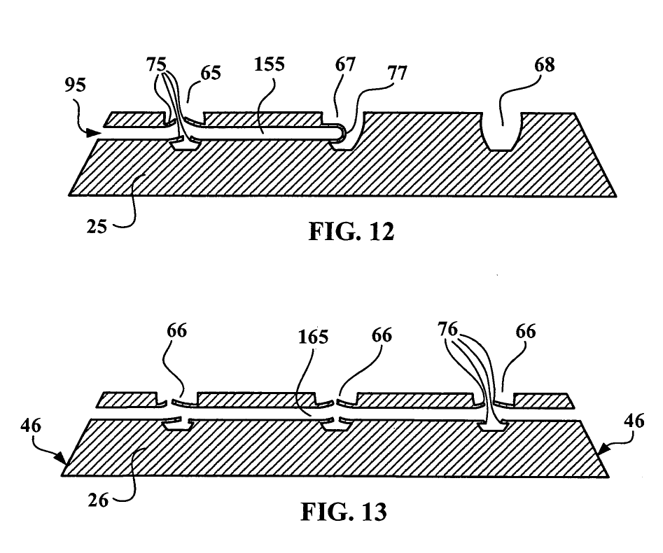

Of course, the process according to the invention makes it possible to obtain, in one and the same tread, channels which cross some grooves and open into only one sidewall of other grooves. FIG. 12 shows schematically a tread 25 obtained by the process of the invention. The tread 25 has three grooves 65, 67 and 68 and one channel 155 that extends from an orifice 95 in a lateral face of the tread 25 as far as the axial centre of the tread 25. The channel 155 crosses the groove 65 and ends within the groove 67. The film 75 surrounding the channel 155 within the groove 65 is deformed and then tears during the extraction of the ridge that has molded the groove 65. During the second stage of the process according to the invention, the films 75 and 77 of mix formed in the grooves 65 and 67 are ablated.

As shown in FIG. 13, the process according to the invention also makes it possible to obtain a tread 26 comprising channels 165 that open onto both lateral faces 46 of the tread and cross all the grooves 66. During the second stage of the process according to the invention, the film 76 of mix formed in each of the grooves 66 is ablated.

Those skilled in the art will understand that the principle of the invention can be applied equally well in cases when it is desired to mold channels in only one lateral face 4 (FIG. 1) of the tread or in both lateral faces. The channels in opposite lateral faces can be arranged symmetrically or not. The crown sectors 30 can cover the full width of the tread or only part thereof.

The number of channels 5 and their precise geometry are determined as a function of the result sought in the finished tread. Each sector can have several pins 70 or, on the contrary, some sectors may have no pin 70 at all.

It is also possible for the crown sectors 30 to have pins 70 provided that the pins 70 are axially movable relative to the crown sectors 30.

Channels 5 can be arranged axially or along a direction oblique relative to the tire's axis. Similarly, the radial cross-section of at least one channel can vary along the direction of the channel's largest dimension.

The process according to the invention allows treads to be obtained which are or are not annular, of finite length or on the contrary quasi-infinite length, continuous and flat. This allows the production not only of treads intended for the production or retreading of tires, but also of rubber caterpillar tracks.

1. A process for obtaining a tire (1) tread (2; 21; 22; 23; 25; 26) made from rubber mix, the said tread (2; 21; 22; 23; 25; 26) comprising a running surface (3) bounded axially by lateral faces (4; 46), at least one groove (6; 61; 62; 63; 65; 66; 67) bounded by two sidewalls (15, 51; 27, 72; 35, 53) and at least one channel located radially below the running surface (3) and opening onto at least one lateral face (4; 46) of the tread (2; 21; 22; 23; 25; 26) and into at least one sidewall (15, 51; 27, 72; 35, 53) of at least one groove (6; 61; 62; 63; 65; 66; 67), the said process comprising the following stages:
molding of the tread (2; 21, 22; 23; 25; 26) with at least one groove (6; 61; 62; 63; 65; 66; 67) and at least one channel (5; 155; 165) that opens onto at lest one lateral face (4; 46) of the tread (2; 21; 22; 23; 25; 26), the said channel (5; 155; 165) extending into the groove (6; 61; 62; 63; 65; 66; 67) in such manner that at least one plane which is locally tangential to the part, radially external to the channel (5; 155; 165), of at least one sidewall (15, 51; 27, 72; 35, 53) into which the channel (5; 155; 165) opens, divides the channel (5; 155; 165) into two parts (115, 215; 125, 225; 135, 235).
ablation, after vulcanization, of at least part of the mix molded around the channel (5; 155; 165) inside the groove (6; 61; 62; 63; 65; 66; 67).

2. The process according to claim 1, wherein the channel (5; 155) is extended into the groove (6; 61; 62; 67) by a protuberance (7).

3. The process according to claim 2, wherein the axial distance (d) between at least one plane (101; 102; 103) that is locally tangential to the part, radially external to the channel (5; 155), of the sidewall (8; 15; 27) on which the protuberance (7) forms a protrusion and the point of the inside surface of the channel (5; 155) closest to the sidewall (51; 72) of the groove (6; 61; 62; 67) opposite the sidewall on which the protuberance (7) forms a protrusion, is larger than 20% of the mean width (L) of the groove (6; 61; 62; 67).

4. The process according to claim 1, wherein the channel (155; 165) crosses the said groove (63; 65; 66) so that a first part (135) of the channel (155; 165) opens both onto a lateral face of the tread and into a sidewall (35) of the groove (63; 65; 66), and another part (235) of the channel (155; 165) opens opposite the first part into the opposite sidewall (53) of the groove.

5. The process according to any of claims 1 to 4, wherein all of the mix surrounding the channel (5; 155; 165) within the said groove (6; 61; 62; 63; 65; 66; 67) at the end of the molding stage is removed during the ablation stage.

6. The process according to any of claims 1 to 5, wherein ablation is carried out with the tire (1) in rotation, by cutting by means of a blade introduced into the groove (6; 61; 62; 63; 65; 66; 67), following the profile of the groove (6; 61; 62; 63; 65; 66; 67).

7. The process according to any of claims 1 to 5, wherein ablation is carried out with the tire (1) in rotation, by means of a grinding wheel (80) introduced into the groove (6; 61; 62; 63; 65; 66; 67), following the profile of the groove (6; 61; 62; 63; 65; 66; 67).

8. The process according to any of claims 1 to 5, wherein ablation is carried out with the tire (1) in rotation, by means of a laser beam, following the profile of the groove (6; 61; 62; 63; 65; 66; 67).
